(19) United States
(12) Patent Application Publication
(10) Pub. No.: US 2019/0188620 A1
(43) Pub. Date: Jun. 20, 2019

(54) SYSTEM AND METHOD FOR LOCATION SENSOR ASSOCIATION

(71) Applicant: Caterpillar Paving Products Inc., Brooklyn Park, MN (US)

(72) Inventors: John L. Marsolek, Watertown, MN (US); Jacob J. McAlpine, Otsego, MN (US)

(73) Assignee: Carerpillar Paving Products Inc., Brooklyn Park, MN (US)

(21) Appl. No.: 15/841,447

(22) Filed: Dec. 14, 2017

(51) Int. Cl. G06Q 10/06; G01S 19/51; G06Q 50/08; H04W 4/021

(52) U.S. Cl. CPC G06Q 10/06315; H04W 4/021; G06Q 50/08; G01S 19/51

(57) ABSTRACT

A method includes receiving, with a controller of a paving plant, a first signal from a location sensor associated with a haul truck, the first signal including information indicating a first location of the haul truck. The method also includes generating a paving material ticket with the controller, the paving material ticket including a first identifier unique to the haul truck. The method further includes determining, with the controller, whether the first location is within a first geofence disposed within a perimeter of the paving plant. The controller is also configured to associate the first identifier with the location sensor in a memory connected to the controller.

### TECHNICAL FIELD

The present disclosure relates to a paving system. More specifically, the present disclosure relates to a paving system having a controller configured to associate a haul truck identifier with a location sensor.

### BACKGROUND

Haul trucks, paving machines and other equipment are often used to perform a variety of tasks associated with a paving worksite. For example, a haul truck may be used to transport paving material from a paving plant to a worksite so that the paving material can be distributed along a paving surface by one or more paving machines. The operation of such machines must be coordinated in order to perform paving operations in an efficient manner. In particular, it may be useful to monitor the location of one or more haul trucks so that the delivery of paving material to the worksite can be managed accurately.

An example system for coordinating the activities of paving machines is described in U.S. Patent Application Publication No. 2013/0290062 (hereinafter referred to as the '062 reference). In particular, the '062 reference describes a system for implementing a computer-based method of coordinating activities associated with paving a roadway. The '062 reference describes, for example, a server configured to provide communication among system components. As explained in the '062 reference, the server may receive a communication from a transport truck indicating that a batch of paving material has been delivered to the roadway, and such a communication may be generated automatically by a truck computer system in conjunction with a global positioning system (GPS) receiver on the truck. The '062 reference does not, however, disclose details related to ensuring that a particular location sensor monitoring the location of a respective truck has been accurately matched or otherwise associated with the truck. As a result, errors may occur when coordinating the activities of such trucks and other paving equipment.

Example embodiments of the present disclosure are directed toward overcoming the deficiencies described above.

### SUMMARY

In an aspect of the present disclosure, a method includes receiving, with a controller of a paving plant, a first signal from a location sensor associated with a haul truck, the first signal including information indicating a first location of the haul truck determined by the location sensor. Such an example method also includes generating a paving material ticket with the controller, the paving material ticket including information indicating paving material loaded into the haul truck at the paving plant and a first identifier unique to the haul truck. Such a method further includes determining, with the controller, whether the first location is within a first geofence disposed within a perimeter of the paving plant. Based at least partly on determining that the first location is within the first geofence, the controller is configured to associate the first identifier with the location sensor in a memory connected to the controller.

In another aspect of the present disclosure, a paving system includes a haul truck configured to transport paving material between a paving plant and a worksite, the haul truck including a first identifier unique to the haul truck. Such an example paving system also includes a location sensor configured to determine a location of the haul truck, and a controller disposed at the paving plant and in communication with the location sensor. In such examples, the controller is configured to receive a first signal from the location sensor, the first signal including information indicating a first location of the haul truck determined by the location sensor. The controller is also configured to generate a paving material ticket based at least partly on the haul truck receiving paving material at the paving plant, the paving material ticket including the first identifier. The controller is further configured to determine whether the first location is within a first geofence disposed within a perimeter of the paving plant. Based at least partly on determining that the first location is within the first geofence, the controller is configured to associate the first identifier with the location sensor in a memory connected to the controller.

In yet another aspect of the present disclosure, a control system includes a location sensor configured to determine a location of a haul truck, a controller, and a wireless communication system configured to transmit signals between the location sensor and the controller. In such examples, the controller is configured to receive a first signal from the location sensor and via the wireless communication system, the first signal including information indicating a first location of the haul truck determined by the location sensor. In such examples, the controller is also configured to receive an input including information indicating a first identifier unique to the haul truck. The controller is further configured to generate a paving material ticket, the paving material ticket including information indicating paving material loaded into the haul truck, and the first identifier. Additionally, the controller is configured to determine whether the first location is within a first geofence disposed within a perimeter of a paving plant. Based at least partly on determining that the first location is within the first geofence, the controller is configured to associate the first identifier with the location sensor in a memory connected to the controller.

### BRIEF DESCRIPTION OF DRAWINGS

FIG. 1 is a schematic illustration of a paving system in accordance with an example embodiment of the present disclosure.

FIG. 2 is a schematic illustration of a paving plant in accordance with an example embodiment of the present disclosure.

FIG. 3 is a flow chart depicting a method of associating a location sensor with a haul truck in accordance with an example embodiment of the present disclosure.

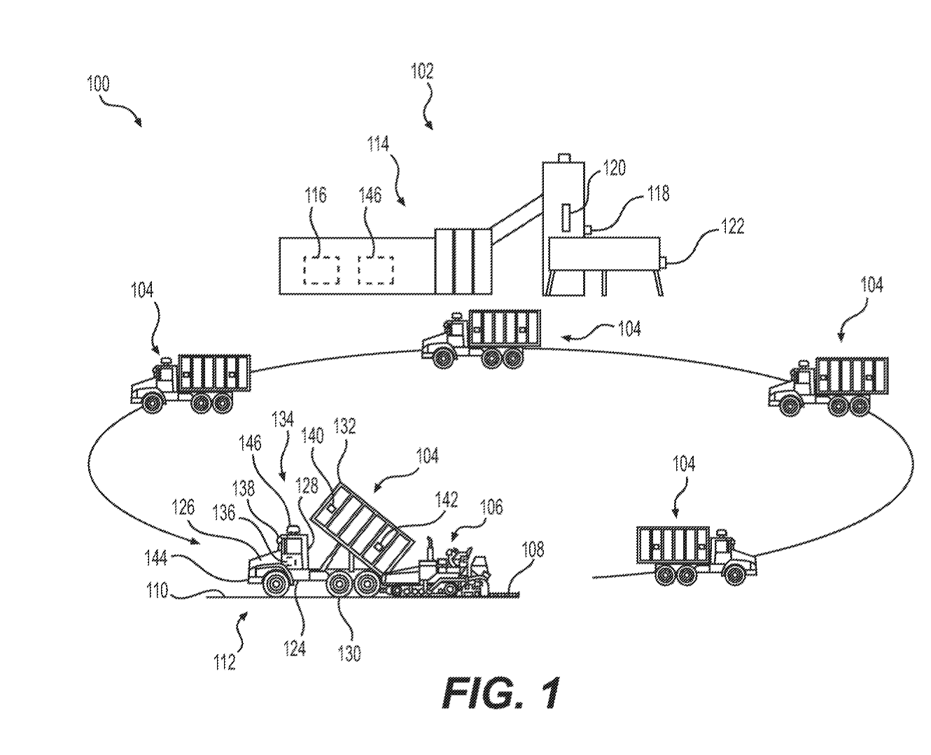

### DETAILED DESCRIPTION

Wherever possible, the same reference numbers will be used throughout the drawings to refer to the same or like parts. Referring to FIG. 1, an example paving system 100 may include one or more paving plants 102 for producing a paving material 108 such as asphalt, and a plurality of machines such as one or more haul trucks 104 for transporting paving material 108, and one or more paving machines 106 for applying a layer (e.g., a mat) of paving material 108 such as asphalt to a work surface 110 at a worksite 112. Other machines, such as compactors (not shown) and remixing transfer vehicles (not shown) may also form a portion of the paving system 100. Such an example worksite 112 may include, for example, a construction site, a roadwork site, a parking lot, or any other type of job site. In some examples, one or more haul trucks 104 may be operative to transport paving material 108 from the paving plant 102 to a paving machine 106 at the worksite 112. In particular, a haul truck 104 may be loaded with paving material 108 at the paving plant 102. The haul truck 104 may then travel to the appropriate paving machine 106 at the worksite 112, and transfer the paving material 108 to the paving machine 106. The paving machine 106 may then apply the paving material 108 to the work surface 110.

The paving plant 102 may produce paving material 108 such as asphalt from bitumen, aggregate, and other materials or fillers. The paving material 108 is often produced in batches with each batch stored or held in a separate storage or holding location such as a silo until it is loaded into a haul truck 104 at a loading station. Each holding location may be dedicated to storing or holding paving material 108 for a particular worksite 112 and paving material 108 within a particular holding location is periodically loaded into a haul truck 104 for transport to the worksite 112. The characteristics of each batch stored within a holding location may be set based upon the desired characteristics for a particular paving job. For example, the amount of oil and the size of the aggregate may be set based upon the desired characteristics of the paving material 108 and the requirements of each paving job.

Each batch may be periodically or continuously mixed at the holding location and maintained at a desired temperature. The temperature at which the paving material 108 is maintained may be set based upon a desired temperature at which the paving material 108 will be loaded into the haul trucks 104. Such loading temperature may be based upon the desired temperature at which the load will be delivered to the paving machine 106, the ambient temperature of the air, the expected time required for the haul truck 104 to drive from the paving plant 102 to the paving machine 106 as well as any expected or anticipated waiting time for the haul 104 truck at the worksite 112.

The paving system 100 shown in FIG. 1 may include a control system 114 and one or more controllers 116. In some examples, the control system 114 and/or the controller 116 may be located at the paving plant 102. In such examples, the control system 114 and/or the controller 116 may also include components located remotely from the paving plant 102 such as on any of the machines of the paving system 100, at the worksite 112, and/or at a remote command center (not shown). The functionality of controller 116 may be distributed so that certain functions are performed at paving plant 102 and other functions are performed remotely. For example, some functions of the controller 116 may be performed at the worksite 112, on one or more of the haul trucks 104, one or more of the paving machines 106, etc. It is understood that the controller 116 may comprise a component of the paving system 100, the paving plant 102, and/or the control system 114.

The paving system 100 and/or the control system 114 may also include a plurality of sensors such as one or more temperature sensors 118 operative to monitor the temperature of the paving material 108 within each holding location. The term “sensor” is used herein in its broadest sense to include one or more sensors and related components that may cooperate to sense various functions, operations, and operating characteristics of a machine or system and/or aspects of the environment in which the machine or system is operating. The paving system 110 and/or the control system 114 may also include one or more volume and/or weight sensors 120 configured to determine an amount and/or weight of paving material 108 remaining at the holding location. The paving system 110 and/or the control system 114 may further include one or more loading sensors 122 configured to determine an amount and/or weight of paving material 108 being loaded onto a haul truck 104 at the loading station.

Information regarding the paving plant 102, the paving material 108, one or more of the haul trucks 104, and/or one or more of the paving machines 106 may be stored or determined by controller 116. Some of the information may be relatively static (i.e., static or fixed for each batch of paving material 108) and other information may be dynamic or change. Examples of static information include a unique identifier associated with the batch. Dynamic information that may be stored or determined by the controller 116 includes the amount and temperature of the paving material 108 within a holding location at the paving plant 102. In many instances, the characteristics of each batch (e.g., amount of oil and size of the aggregate) may be static information. However, in some instances, the characteristics of each batch may change or be modified based upon the feedback or requests from the worksite 112 or other personnel and thus may be considered dynamic information. Further, as will be described below, the controller 116 may be configured to receive, store, and/or periodically update information associated with the location of one or more haul trucks 104, a unique identifier associated with each respective haul truck 104, a location sensor disposed on or removably located within one or more of the haul trucks 104, and/or other information associating a respective haul truck 104 with a corresponding location sensor.

In some examples, the controller 116 may comprise one or more servers, computers, and/or other electronic control modules. The controller 116 may receive input signals from one or more of the temperature sensors 118, volume and/or weight sensors 120, loading sensors, haul trucks 104, paving machines 106, and/or other sensors of components of the paving system 100. The controller 116 may also receive input signals from systems outside of the paving system 100 such as GPS signals (e.g., latitude coordinates, longitude coordinates, and/or other global positioning information), and signals indicative of traffic and weather that may affect the operation of the paving system 100 or the paving process. The controller 116 may control the operation of various aspects of the paving plant 102, as well as various operations of one or more of the haul trucks 104, paving machines 106, and/or the machines of the paving system 100. In some examples, the controller 116 may also generate desired communication signals to each of the haul trucks 104, paving machines 106, and/or the machines of the paving system 100.

The controller 116 may be an electronic controller that operates in a logical fashion to perform operations, execute control algorithms, store and retrieve data and other desired operations. The controller 116 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller 116 such as power supply circuitry, signal conditioning circuitry, driver circuitry, and other types of circuitry.

The controller 116 may be a single controller or may include more than one controller (such as additional controllers associated with each of the haul trucks 104, paving machines 106, and/or other machines of the paving system 100) configured to control various functions and/or features of the paving system 100. As used herein, the term “controller” is meant in its broadest sense to include one or more controllers and/or microprocessors that may be associated with the paving system 100, and that may cooperate in controlling various functions and operations of the paving plant 102 and the machines of the paving system 100. The functionality of the controller 116 may be implemented in hardware and/or software without regard to the functionality. The controller 116 may rely on one or more data maps relating to the operating conditions and the operating environment of the paving system 100 that may be stored in the memory of the controller 116. Each of these data maps may include a collection of data in the form of tables, graphs, and/or equations to maximize the performance and efficiency of the paving system 100 and its operation.

The haul trucks 104 of the paving system 100 may be operative to transport paving material 108 between the paving plant 102 and one or more of the paving machines 106 located at the worksite 112. More specifically, at the paving plant 102, a haul truck 104 may be loaded with paving material 108 at a desired temperature. The haul truck 104 may then travel to the appropriate paving machine 106 or a remixing transfer vehicle (not shown), and the paving material 108 may subsequently be applied to the work surface 110 as a layer of paving material 108. Each haul truck 104 may include a chassis 124 that supports a prime mover such as an engine 126, and a cab 128 in which an operator may be positioned to provide input instructions to operate the haul truck 104. The engine 126 is operatively connected to and drives a ground engaging drive mechanism such as wheels 130. A material transport unit such as a dump body 132 is pivotally mounted on the chassis 124 and receives a payload (e.g., paving material 108) to be hauled from one location to another.

Each haul truck 104 may include a truck control system 134 and a truck controller 136 generally similar or identical to the control system 114 and the controller 116, respectively. The truck control system 134 and the truck controller 136 may be located on the haul truck 104 and may also include components located remotely from the haul truck 104 such as on any of the other machines of the paving system 100, at the paving plant 102, or at a command center (not shown). The functionality of truck controller 136 may be distributed so that certain functions are performed on the haul truck 104 and other functions are performed remotely.

The haul truck 104 may also be equipped with a plurality sensors connected to and/or otherwise in communication with the truck controller 136 and/or with the controller 116. Such sensors may be configured to provide data indicative (directly or indirectly) of various operating parameters of the haul truck 104, systems associated with the haul truck 104, and/or the worksite 112 and/or other environment in which the haul truck 104 is operating. In any of the examples described herein, such sensors may comprise components of the control system 114 and/or the paving system 110, generally. For example, the haul truck 104 may be equipped with a location sensor 138 configured to sense, detect, and/or otherwise determine a location and/or orientation of the haul truck 104. The location sensor 138 may include a plurality of individual sensors that cooperate to generate and provide location signals to the truck controller 136 and/or to the controller 116 indicative of the location and/or orientation of the haul truck 104. In some examples, the location sensor 138 may be fixed to the cab 128, the chassis 124, and/or any other component of the haul truck 104. In other examples, however, the location sensor 138 may be removably attached to the haul truck 104 and/or disposed within, for example, the cab 128 of the haul truck 104 during operation of the haul truck 104. In such examples, the location sensor 138 may comprise one or more portable location sensors 138 that may be removably disposed within the cab 128 by an operator of the haul truck 104 during operation of the haul truck 104. In any of the examples described herein, the location sensor 138 may include one or more sensors that interact with a positioning system such as a global navigation satellite system or a global positioning system to operate as a location sensor. The truck controller 136 and/or the controller 116 may use information included in one or more signals received from the location sensor 138 to determine the location of the haul truck 104 relative to an earth reference (e.g., GPS), relative to one or more geofences of the present disclosure, relative to another machine such as the paving machine 106, and/or relative to the paving plant 102 or one or more components of the paving plant 102.

In some examples, the haul truck 104 may also include a load sensor 140 configured to sense, measure, and/or otherwise determine the load or amount of paving material 108 disposed within the dump body 132. The haul truck 104 may further include a temperature sensor 142 configured to sense, measure, and/or otherwise determine the temperature of the load (e.g., paving material 108) within the dump body 132. Further, as shown in FIG. 1, each haul truck 104 may include a unique identifier 144 connected thereto and/or otherwise associated therewith. The unique identifier 144 may comprise a license plate number, a haul truck code, an alphanumeric code, a radio frequency identification tag, a near-field communication emitter/transponder, a barcode, a QR code, and/or any other identifier, device, or component uniquely identifying a respective one of the haul trucks 104. Such unique identifiers 144 may be located at the front of the haul truck 104 (e.g., on a front bumper of the haul truck 104), at the rear of the haul truck 104 (e.g., at a rear bumper or rear tailgate of the haul truck 104), at a side panel of the haul truck 104 (e.g., on an outer sidewall of the dump body 132), and/or at any other location on the haul truck 104 easily visible and/or accessible by an observer at the worksite 112 and/or at the paving plant 102.

In example embodiments, the control system 114 and/or the paving system 100, generally, may also include a wireless communication system 146 to permit wireless transmission of a plurality of signals, instructions, and/or information between the paving plant 102, the haul trucks 104, and the paving machines 106, as well as to permit communication with other machines and systems remote from the paving plant 102, haul trucks 104, and paving machines 106. For example, the wireless communication system 146 may include one or more components configured to transmit signals between one or more of the location sensors 138, the controller 116, and/or other components of the control system 114. In an example embodiment of the present disclosure, each wireless communication system 146 may include a transmitter configured to transmit signals to a receiver of one or more other wireless communication systems 146. In such examples, each wireless communication system 146 may also include a receiver configured to receive signals from a transmitter of one or more other wireless communication systems 146. In some examples, the transmitter and the receiver of a particular wireless communication system 146 may be combined as a transceiver or other such component.

The wireless communication systems 146 described herein may implement or utilize any desired system or protocol including any of a plurality of communications standards. The desired protocols will permit communication between the controller 116, one or more of the location sensors 138, the paving plant 102, one or more haul trucks 104, one or more paving machines 106, and/or any other desired machines or systems. Examples of wireless communications systems or protocols that may be used by the wireless communication systems 146 describe herein include a wireless personal area network such as Bluetooth® (e.g., IEEE 802.15), a local area network such as IEEE 802.11b or 802.11g, a cellular network, or any other system or protocol for data transfer. Other wireless communication systems 146 and configurations are contemplated. In some instances, wireless communications may be transmitted and received directly between the paving plant 102 and a machine or between machines. In other instances, the communications may be automatically routed without the need for re-transmission by remote personnel.

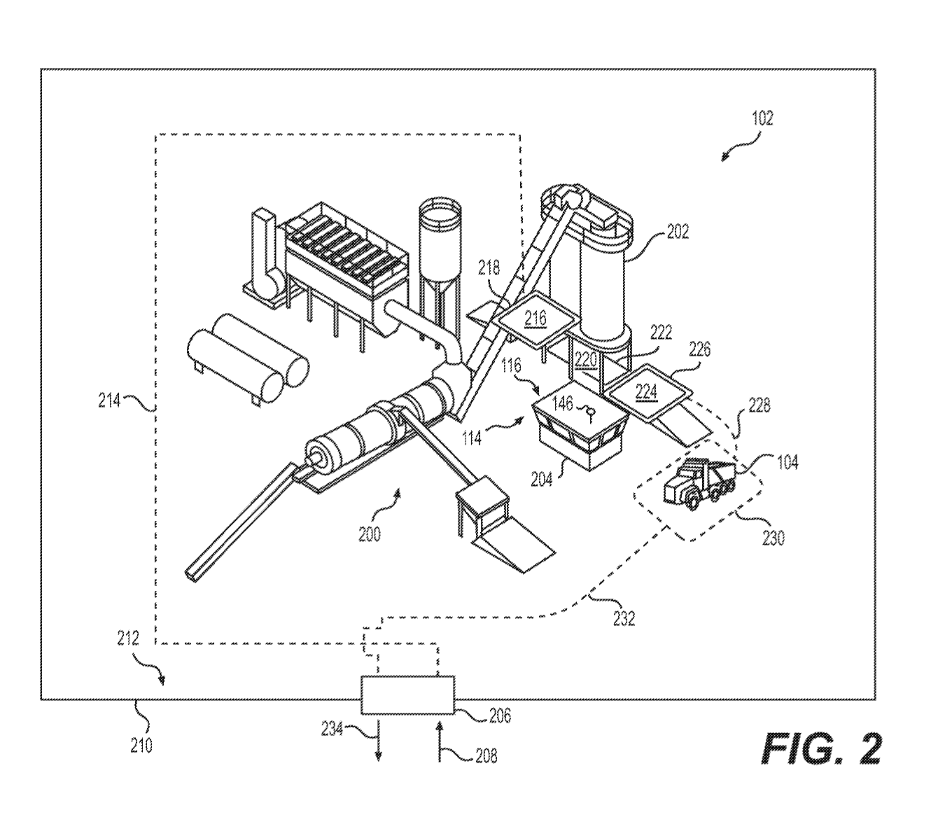

FIG. 2 illustrates an example paving plant 102 of the present disclosure in greater detail. As shown in FIG. 2, the paving plant 102 includes various material delivery components, mixers, heaters, and/or other equipment 200 configured to assist in manufacturing paving material 108 for use in various paving operations. Such equipment 200 may include, for example, one or more conveyors or other devices configured to transport paving material 108 to one or more paving material silos 202 or other holding locations for storage therein. The paving plant 102 may also include one or more scale houses 204 for use by plant personnel. As indicated in FIG. 2, one or more components of the control system 114 may be housed in and/or otherwise located at the scale house 204. For example, in some embodiments the controller 116 may be located within the scale house 204. Additionally, a receiver, transmitter, transceiver, and/or one or more other components of the wireless communication system 146 may be located at the scale house 204. Such components may be configured to receive one or more signals from and/or send one or more signals to, for example, various location sensors 138 (FIG. 1) disposed on or in one or more of the haul trucks 104. Such components of the wireless communication system 146 may also be configured to receive one or more signals from and/or send one or more signals to, for example, various temperature sensors 118 (FIG. 1), volume and/or weight sensors 120 (FIG. 1), loading sensors 122 (FIG. 1), load sensors 140 (FIG. 1), temperature sensors 142 (FIG. 1), and/or other wireless communication systems 146 or components.

The paving plant 102 may include one or more gates 206, and such gates 206 may comprise respective entrances and/or exits to the paving plant 102. Such gates 206 may, for example, be configured to permit passage of a haul truck 104 into the paving plant 102 in the direction 208. In any of the examples described herein, one or more components of the control system 114 may be configured to sense, detect, and/or otherwise determine passage of the haul truck 104 through the gate 206, and such components may also be configured to determine whether the haul truck 104 is located within the paving plant 102. For example, the control system 114 may include one or more geofences configured to assist in determining the location of a haul truck 104. In example embodiments, a geofence may comprise, for example, a virtual geographic boundary defined by GPS, cellular, near-field communication, radio frequency identification (RFID), and/or other components of the control system 114. Such geofences may enable the controller 116, software operable on the controller 116, and/or other components of the control system 114 to generate a signal or other response when a location sensor 138 carried by a haul truck 104 enters or leaves the virtual geographic boundary of the geofence. In some examples, the respective location sensors 138 may emit signals continuously, substantially continuously, or at predetermined intervals (e.g., every second, every two seconds, every five seconds, every ten seconds, every 15 seconds, etc.), and such signals may include information indicating the location of the haul truck 104 within which the location sensor 138 is disposed. In such examples, the controller 116 may be configured to determine whether the location sensor 138 and, thus, the haul truck 104 is located within one or more geofences of the control system 114 based at least partly on such signals.

As shown in FIG. 2, the control system 114 may include a geofence 210 extending substantially along and/or otherwise substantially overlaying a perimeter 212 of the paving plant 102. Such a geofence 210 may, thus, correspond to an outer boundary of the paving plant 102, and a haul truck 104 may pass into the geofence 210 when entering the paving plant 102 via the gate 206. Upon entering the paving plant 102 via the gate 206, a haul truck 104 may travel along a path 214 extending between the gate 206 and a location 216 within the perimeter 212 of the paving plant 102 corresponding to one or more of the holding locations described herein. For example, the location 216 may comprise an entrance to the paving material silo 202 at the paving plant 102. In such examples, the control system 114 may also include a geofence 218 extending substantially along and/or otherwise substantially overlaying a perimeter of the location 216. In such examples, the geofence 218 may define a virtual boundary of the location 216, and the location 216 may be within the geofence 218. It is understood that a haul truck 104 may be located at location 216 and thus, within the geofence 218, before entering a loading area of the paving material silo 202 disposed adjacent to the entrance.

For example, a location 220 substantially beneath the paving material silo 202 may comprise a loading area of the paving material silo 202 at which the haul truck 104 may receive paving material 108 into the dump body 132. In such examples, the control system 114 may further include a geofence 222 extending substantially along and/or otherwise substantially overlaying a perimeter of the location 220. For example, the geofence 222 may define a virtual boundary of the location 220, and the location 220 may be within the geofence 222. Additionally, the geofence 218 may be disposed adjacent to the geofence 222. Further, a location 224 adjacent to the location 220 may comprise an exit of the paving material silo 202 at which the haul truck 104 may be weighed, observed, and/or otherwise evaluated. As shown in FIG. 2, in some examples, the control system 114 may also include a geofence 226 extending substantially along and/or otherwise substantially overlaying a perimeter of the location 224. For example, the geofence 226 may define a virtual boundary of the location 224, and the location 224 may be within the geofence 226. In such examples, the geofence 222 may be disposed adjacent to the geofence 226.

In some examples, upon exiting the location 224 a haul truck 104 may travel along a path 228 extending between the location 224 and a location 230 proximate the scale house 204. In such examples, the haul truck 104 may temporarily stop at the location 230, such that an operator of the haul truck 104 may receive a paving material ticket associated with the paving material 108 received at the paving material silo 202. In some examples, such a paving material ticket may comprise a text file, an image file, a data file, and/or any other digital or electronic file configured to contain information, and to be executed and/or otherwise consumed by a server, a computer, a mobile phone, and/or other electronic device. Such a paving material ticket may be saved within a memory connected to the controller 116, and may be transmitted to one or more additional electronic devices (e.g., an electronic device carried by the operator of the haul truck 104, the truck controller 136, etc.) via, for example, the wireless communication system 146. Additionally or alternatively, such a paving material ticket may comprise a physical card, ticket, piece of paper, or other physical object including any of the information described herein and configured for consumption by a human. Such a paving material ticket may be printed on a printer or other device connected to the controller 116.

An example paving material ticket may include information indicating the weight, volume, composition, temperature, and/or other characteristics of the paving material 108 deposited into the dump body 132 at the location 220. Such a paving material ticket may also include information identifying the worksite 112 at which the paving material 108 will be utilized. In further examples, such a paving material ticket may also include information uniquely identifying the particular haul truck 104 receiving such paving material 108 at the location 220. For example, a paving plant employee may observe the unique identifier 144 associated with a particular haul truck 104 during inspection of the haul truck 104 in at least one of the locations 216, 220, 224. In such examples, the paving plant employee may record the unique identifier 144, and may provide an input to the controller 116 including information indicating the unique identifier 144. Alternatively, one or more cameras, scanners, RFID readers, near-field communication scanners, barcode readers, or other detection devices may automatically capture and/or otherwise observe the unique identifier 144 during inspection of the haul truck 104 in at least one of the locations 216, 220, 224. In such examples, the one or more cameras or other detection devices may send a signal to the controller 116 including information indicating the unique identifier 144. In any of the examples described herein, the controller 116 may generate the paving material ticket based at least partly on the haul truck 104 receiving the paving material 108 at the paving material silo 202 of the paving plant 102, and an example paving material ticket may include the unique identifier 144 identifying the particular haul truck 104. Further, any of the paving material tickets described herein may include a timestamp indicating the date and/or time at which the paving material ticket was generated.

Upon receiving the paving material ticket at the location 230, the haul truck 104 may travel from the location 230 to the gate 206 via a path 232. Upon reaching the gate 206, the haul truck 204 may pass through the gate 206 in order to exit the paving plant 102. In particular, the haul truck 104 may pass through the gate 206 in the direction 234. By passing through the gate 206 in the direction 234, the haul truck 104 may also exit the geofence 210 corresponding to the perimeter 212 of the paving plant 102.

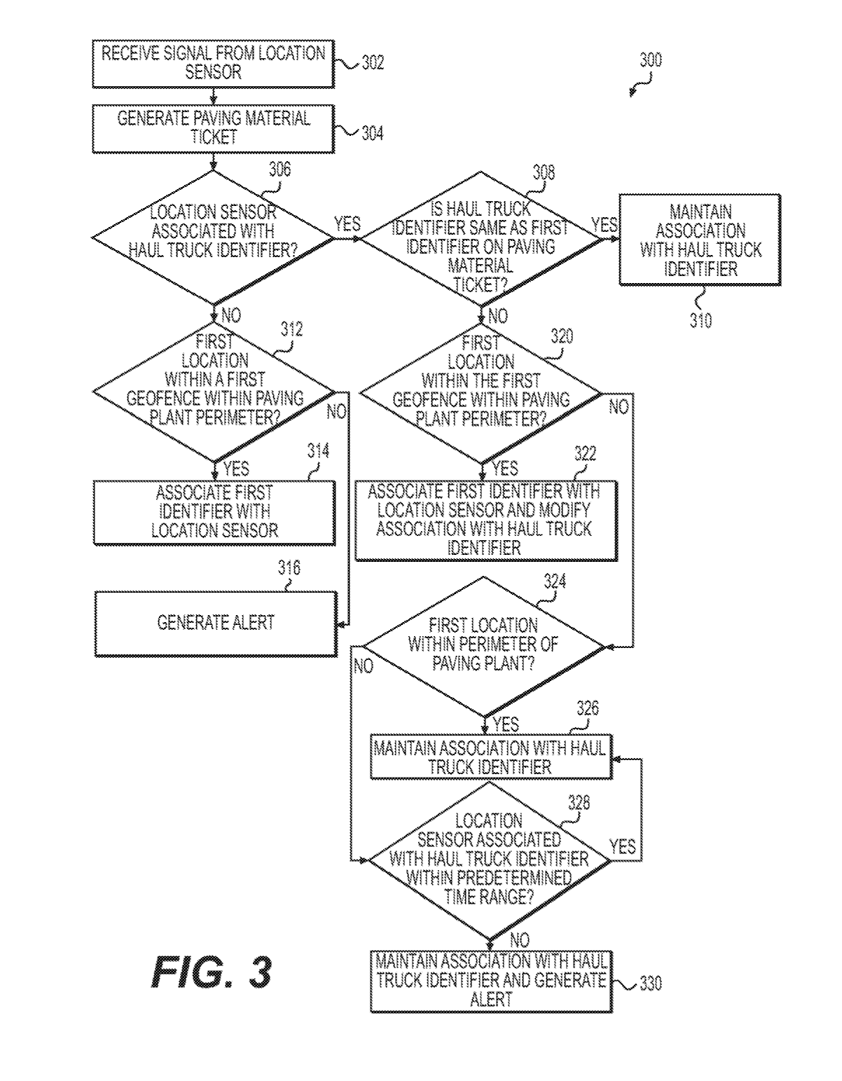

FIG. 3 illustrates a flow chart depicting an example method 300 of associating a unique identifier 144 of a particular haul truck 104 with a respective location sensor 138 connected to or disposed within the particular haul truck 104. The example method 300 is illustrated as a collection of steps in a logical flow diagram, which represents operations that can be implemented in hardware, software, or a combination thereof. In the context of software, the steps represent computer-executable instructions stored in memory. When such instructions are executed by, for example, the controller 116, such instructions may cause the controller 116, various components of the control system 114, the wireless communication system 146, and/or the haul truck 104 to perform the recited operations. Such computer-executable instructions may include routines, programs, objects, components, data structures, and the like that perform particular functions or implement particular abstract data types. The order in which the operations are described is not intended to be construed as a limitation, and any number of the described steps can be combined in any order and/or in parallel to implement the process. For discussion purposes, and unless otherwise specified, the method 300 is described with reference to the paving system 100, the control system 114, the paving plant 102, and/or other items shown in FIGS. 1 and 2.

An example work cycle of a haul truck 104 may include receiving a load of paving material 108 at the paving material silo 202 of the paving plant 102, transporting the paving material 108 to the worksite 112, depositing the paving material 108 in a hopper or other component of a paving machine 106, and returning to the paving plant 102 to receive another load of paving material 108 for use at the worksite 112. As part of such a work cycle and/or when a particular haul truck 104 is first onboarded into a fleet of machines at the paving plant 102, the controller 116 may, at 302, receive one or more signals from a location sensor 138. As noted above, such a location sensor 138 may be fixed to the cab 128, the chassis 124, and/or any other component of the haul truck 104. In other examples, however, the location sensor 138 may be removably attached to the haul truck 104 and/or disposed within, for example, the cab 128 of the haul truck 104 during operation of the haul truck 104. In such examples, the location sensor 138 may comprise one or more portable location sensors 138 that may be removably disposed within the cab 128 by an operator of the haul truck 104.

In any of the examples described herein, one or more such signals received at 302 may include information (e.g., GPS coordinates, map information, a location name, and/or other information determined by the location sensor 138) indicating a first location of the haul truck 104 determined by the location sensor 138. One or more such signals may also include a first timestamp indicating a first time (e.g., day, month, year, hour, minute, second, millisecond, etc.) at which the first location of the haul truck 104 and/or other information included in the corresponding first signal was determined by the location sensor 138. In additional examples, one or more such signals received by the controller 116 at 302 may also include a second identifier unique to an/or otherwise uniquely identifying the particular location sensor 138 disposed on or within the haul truck 104. Similar to the unique identifier 144 associated with the haul truck 104, such a second identifier, may comprise one or more alphanumeric codes or other indicia useful in uniquely identifying the location sensor 138. In some examples, the first location of the haul truck 104 may comprise a location at the worksite 112 or a location at the paving plant 102. In some examples, the first location of the haul truck 104 described above with respect to 302 may comprise the location 216 at the entrance to the paving material silo 202, and/or any other location within the perimeter 212 of the paving plant 102. In other examples, the first location of the haul truck 104 described above with respect to 302 may comprise a location outside of the perimeter 212 of the paving plant 102.

In any of the examples described herein, a paving material ticket may be generated by the controller 116 when the haul truck 104 is disposed at one or more locations associated with the paving material silo 202. For example, at 304, the controller 116 may generate a paving material ticket, and such a paving material ticket may include information indicating paving material 108 loaded into the haul truck 104 at the paving plant 102. Such information may include information indicating the weight, volume, composition, temperature, and/or other characteristics of the paving material 108 deposited into the dump body 132 at the paving material silo 202. In some examples, at 304 the controller 116 may generate the paving material ticket based at least partly on the haul truck 104 receiving paving material 108 at the paving plant 102, and in particular, at the paving material silo 202. For example, the controller 116 may generate the paving material ticket at 304 based at least partly on the haul truck 104 being located at one or more of the locations 216, 220, 224 and/or being located within one or more of the geofences 218, 222, 226.

As described above, such a paving material ticket may also include information uniquely identifying the particular haul truck 104 receiving paving material 108 at the paving material silo 202. For example, a paving plant employee may observe the unique identifier 144 associated with a particular haul truck 104 during inspection of the haul truck 104 in at least one of the locations 216, 220, 224. In such examples, the paving plant employee may record the unique identifier 144, and may provide an input to the controller 116 including information indicating the unique identifier 144. Alternatively, one or more cameras or other detection devices may automatically capture and/or otherwise observe the unique identifier 144 during inspection of the haul truck 104 in at least one of the locations 216, 220, 224. In such examples, the one or more cameras or other detection devices may send a signal to the controller 116 including information indicating the unique identifier 144. Accordingly, the paving material ticket generated at 304 may include the unique identifier 144. Further, the paving material ticket generated at 304 may include a second timestamp indicating a second time (e.g., day, month, year, hour, minute, second, millisecond, etc.) at which the paving material ticket was generated.

At 306, the controller 116 may determine whether the location sensor 138 disposed on and/or within the haul truck 104 is currently and/or has been previously associated with a haul truck identifier (e.g., a unique identifier substantially similar to the unique identifier 144 described above). As noted above, one or more signals received by the controller 116 at 302 may include an identifier (e.g., a second identifier) unique to and/or otherwise uniquely identifying the particular location sensor 138 disposed on or within the haul truck 104. In such examples, at 306 the controller 116 may search one or more databases and/or other components of a memory associated with the controller 116 to determine whether the second identifier unique to and/or otherwise uniquely identifying the particular location sensor 138 is indicated in the memory as being associated with a haul truck identifier. If, at 306, the controller 116 determines that the particular location sensor 138 is indicated in the memory as being associated with a haul truck identifier (306—Yes), at 308 the controller 116 may determine whether the haul truck identifier identified at 306 matches, corresponds to, and/or is the same as the unique identifier 144 of the haul truck 104 included in the paving material ticket generated at 304. If, at 308, the controller 116 determines that the haul truck identifier identified at 306 is the same as the unique identifier 144 included in the paving material ticket (308—Yes), the controller 116 may, at 310, maintain the existing association between the location sensor 138 and the haul truck identifier identified at 306.

If, on the other hand, at 306 the controller 116 determines that the particular location sensor 138 is not indicated in the memory as being associated with a haul truck identifier (306—No), at 312, the controller 116 may determine whether the first location of the haul truck 104 determined by the location sensor 138 is within a first geofence disposed within the perimeter 212 of the paving plant 102. In such examples, such a first geofence may comprise one of the geofences 218, 222, 226 described herein with respect to the paving material silo 202. Alternatively, such a first geofence may comprise one or more additional geofences disposed within, for example, the geofence 210 and/or the perimeter 212. Such an additional geofence may be located, for example, at the location, 230 proximate the scale house 204, at the gate 206, and/or at any other locations within the perimeter 212.

If, at 312, the controller 116 determines that the first location of the haul truck 104 determined by the location sensor 138 is within such a first geofence (e.g., within one of the geofences 218, 222, 226) (312—Yes), at 314 the controller 116 may associate (e.g., in the memory connected to the controller 116) the unique identifier 144 of the haul truck 104 with the location sensor 138 from which the first signal was received at 302. For example, at 314 the controller 116 may store the unique identifier 144 included in the paving material ticket generated at 304 in association with the second identifier included in the first signal received at 302. As noted above, in some examples such a second identifier may be unique to and/or may otherwise uniquely identifying the particular location sensor 138 disposed on or within the haul truck 104.

In some examples, the determination at 312 that the first location of the haul truck 104 determined by the location sensor 138 is within such a first geofence (e.g., within one of the geofences 218, 222, 226) may provide a relatively high level of confidence that the unique identifier 144 of the haul truck 104 included in the paving material ticket generated at 304 corresponds to the particular location sensor 138 from which the first signal was received at 302 since, among other things, the unique identifier 144 was directly observed while the haul truck 104 was at the paving material silo 202 and/or proximate the scale house 204. Additionally, at 314, the controller 116 may associate the unique identifier 144 of the haul truck 104 with the location sensor 138 from which the first signal was received based at least partly on the first time included in the first timestamp and the second time included in the second timestamp. In such examples, associating the unique identifier 144 of the haul truck 104 with the location sensor 138 based at least partly on information included in the first timestamp and corresponding information included in the second timestamp may further increase the level of confidence and/or accuracy of the association made by the controller 116 at 314.

For example, as noted above, the first signal received at 302 may include a first timestamp indicating a first time (e.g., day, month, year, hour, minute, second, millisecond, etc.) at which the first location of the haul truck 104 and/or other information included in the corresponding first signal was determined by the location sensor 138. Likewise, the paving material ticket generated at 304 may include a second timestamp indicating a second time (e.g., day, month, year, hour, minute, second, millisecond, etc.) at which the paving material ticket was generated. At 312, the controller 116 may associate the unique identifier 144 of the haul truck 104 with the location sensor 138 (e.g., with the second identifier of the location sensor 138) from which the first signal was received if the first time is identical to the second time. In other examples, the controller 116 may associate the unique identifier 144 of the haul truck 104 with the location sensor 138 if the first time is within a predetermined range of the second time. In such examples, such a predetermined range may be less than one second, less than five seconds, less than ten seconds, less than one minute, and/or any other length of time or time interval. Based at least partly on determining that the first time is within the predetermined range of the second time, the controller 116 may, at 312, associate the unique identifier 144 of the haul truck 104 with the location sensor 138 in a memory connected to the controller 116.

Additionally, in further examples the controller 116 may receive one or more additional signals from the location sensor 138 at 302. In such examples, one or more of the additional signals received at 302 may be utilized by the controller 116 at 314 to associate the unique identifier 144 of the haul truck 104 with the location sensor 138, and use of the information included in such additional signals may also increase the level of confidence and/or accuracy of the association made by the controller 116 at 314. For example, it is understood that the location sensor 138 may generate and/or send such signals continuously, substantially continuously, and/or at predetermined intervals (e.g., every second, every two seconds, every five seconds, every ten seconds, every 15 seconds, etc.), and such signals may include information indicating the location of the haul truck 104 within which the location sensor 138 is disposed. In such examples, the controller 116 may, at 302, receive at least one additional signal (e.g., a second signal) from the location sensor 138, and such a second signal may include information indicating a corresponding second location of the haul truck 104 determined by the location sensor 138. At 312, the controller 116 may determine whether the second location indicated in the second signal is within a second geofence (e.g., the geofence 222 or the geofence 226) disposed within the perimeter 212 of the paving plant 102 different from the first geofence 218 noted above. If, at 312, the controller 116 determines that the second location of the haul truck 104 determined by the location sensor 138 and indicated in the second signal is within such a second geofence (e.g., the geofence 222 or the geofence 226) (312—Yes), at 314, the controller 116 may associate the unique identifier 144 of the haul truck 104 with the location sensor 138 from which the second signal was received in the memory connected to the controller 116 based at least partly on the second signal received at 302.

With continued reference to FIG. 3, if, at 312, the controller 116 determines that the first location of the haul truck 104 determined by the location sensor 138 is outside of the first geofence (e.g., outside of the geofences 218, 222, 226) (312—No), at 316 the controller 116 may generate one or more alarms or other alerts associated with the location sensor 138. For example, determining, at 312, that the first location of the haul truck 104 determined by the location sensor 138 is outside of the perimeter 212 of the paving plant 102 (e.g., outside of the geofence 210) may provide a moderate level of confidence that such a determination was made accurately by the location sensor 138, and that the unique identifier 144 of the haul truck 104 included in the paving material ticket generated at 304 corresponds to the particular location sensor 138 from which the first signal was received at 302. Such a moderate level of confidence may be below a first threshold level of confidence such that, at 316, the controller 116 may generate an alarm to indicate that the identity of the particular location sensor 138 associated with the haul truck 104 should be verified by the operator of the haul truck 104 and/or by an employee of the paving plant 102. Such an alarm may be transmitted directly to the haul truck 104 at 316 via, for example, the paving material ticket and/or via the wireless communication system 146. Additionally or alternatively, such an alarm may be communicated to an employee of the paving plant 102, at 316, via a display connected to the controller 116 and/or by other means. Since the moderate level of confidence described above with respect to 312—No is below a predetermined threshold level of confidence, at 316 the controller 116 may generate the alert without associating the unique identifier 144 of the haul truck 104 with the location sensor 138.

With continued reference to FIG. 3, and as noted above with respect to 306, in some examples the controller 116 may determine that the location sensor 138 providing the signal received at 302 has been and/or is currently associated with a haul truck identifier (306—Yes). In such examples, and based at least partly on such a determination, the controller 116 may also determine, at 308, that such a haul truck identifier is different from the unique identifier 144 included in the paving material ticket generated at 304 (308—No). In such examples, at 320, the controller 116 may determine whether the first location of the haul truck 104 determined by the location sensor 138 is within a first geofence disposed within the perimeter 212 of the paving plant 102. As noted with respect to 312, such a first geofence may comprise one of the geofences 218, 222, 226 described herein with respect to the paving material silo 202. Alternatively, such a first geofence may comprise one or more additional geofences disposed within, for example, the geofence 210 and/or the perimeter 212.

If, at 320, the controller 116 determines that the first location of the haul truck 104 determined by the location sensor 138 is within such a first geofence (e.g., within one of the geofences 218, 222, 226) (320—Yes), at 322 the controller 116 may associate (e.g., in the memory connected to the controller 116) the unique identifier 144 of the haul truck 104 with the location sensor 138 from which the first signal was received at 302. Additionally, at 322 the controller 116 may correct and/or otherwise modify the association between the location sensor 138 and the haul truck identifier identified at 306. In such examples, the controller 116 may modify the haul truck identifier identified at 306 (and previously stored in memory) to match the unique identifier 144. In some examples, at 322 the controller 116 may cancel and/or delete the haul truck identifier identified at 306 (and previously stored in memory), and may replace the haul truck identifier with the unique identifier 144 in memory.

For example, at 322 the controller 116 may store the unique identifier 144 included in the paving material ticket generated at 304 in association with the second identifier included in the first signal received at 302. As noted above, in some examples such a second identifier may be unique to and/or may otherwise uniquely identify the particular location sensor 138 disposed on or within the haul truck 104. In such examples, the determination at 320 that the first location of the haul truck 104 determined by the location sensor 138 is within such a first geofence (e.g., within one of the geofences 218, 222, 226) may provide a relatively high level of confidence that the unique identifier 144 of the haul truck 104 included in the paving material ticket generated at 304 corresponds to the particular location sensor 138 from which the first signal was received at 302 since, among other things, the unique identifier 144 was directly observed while the haul truck 104 was at the paving material silo 202 and/or proximate the scale house 204. Additionally, at 322, the controller 116 may associate the unique identifier 144 of the haul truck 104 with the location sensor 138 from which the first signal was received based at least partly on the first time included in the first timestamp and the second time included in the second timestamp.

On the other hand, if, at 320, the controller 116 determines that the first location of the haul truck 104 determined by the location sensor 138 is outside of such a first geofence (e.g., outside of the geofences 218, 222, 226) (320—No), at 324 the controller 116 may determine whether the first location of the haul truck 104 determined by the location sensor 138 is within the perimeter 212 of the paving plant 102. For example, determining, at 324, that such a first location indicated by the location sensor 138 is within the perimeter 212 of the paving plant 102 may provide a moderate level of confidence that such a determination was made accurately by the location sensor 138, and that the unique identifier 144 of the haul truck 104 included in the paving material ticket generated at 304 corresponds to the particular location sensor 138 from which the first signal was received at 302. For example, at 324 the controller 116 may determine whether the first location of haul truck 104 determined by the location sensor 138 is within the geofence 210 substantially overlaying the perimeter 212. If, at 324, the controller 116 determines that the first location of the haul truck 104 determined by the location sensor 138 is within the perimeter 212 of the paving plant 102 (e.g., within the geofence 210) (324—Yes), at 326 the controller 116 may maintain the association between the haul truck identifier identified at 306 and the location sensor 138. In such examples, the controller 116 may have a relatively low level of confidence that the location sensor 138 from which the first signal was received at 302 is actually disposed on or within the haul truck 104 having the unique identifier 144 included in the paving material ticket generated at 304. For example, such a low level of confidence may be below a second threshold level of confidence (less than the first threshold level of confidence noted above with respect to 316). As a result, at 326 the controller 116 may maintain the association between the haul truck identifier identified at 306 and the location sensor 138 despite receiving an input including contradicting information (e.g., the unique identifier 144).

Alternatively, if at 324 the controller 116 determines that the first location of the haul truck 104 determined by the location sensor 138 is outside of the perimeter 212 of the paving plant 102 (e.g., outside of the geofence 210) (324—No), at 328 the controller 116 may determine whether the location sensor 138 was associated with the haul truck identifier identified at 306 within a predetermined range of the second time indicated on the paving material ticket generated at 304. As noted above, such a predetermined range may be less than one second, less than five seconds, less than ten seconds, less than one minute, and/or any other length of time or time interval. Based at least partly on determining that the location sensor 138 was associated with the haul truck identifier identified at 306 within a predetermined range of the second time indicated on the paving material ticket (328—Yes), the controller 116 may, at 326, maintain the association between the haul truck identifier identified at 306 and the location sensor 138.

On the other hand, if at 328 the controller 116 determines that the location sensor 138 was associated with the haul truck identifier identified at 306 outside of a predetermined range of the second time indicated on the paving material ticket (328—No), the controller 116 may, at 330, maintain the association between the haul truck identifier identified at 306 and the location sensor 138. Additionally, at 330, the controller 116 may generate one or more alarms or other alerts associated with the location sensor 138. In such examples, the controller 116 may have a relatively low level of confidence that the location sensor 138 from which the first signal was received at 302 is actually disposed on or within the haul truck 104 having the unique identifier 144 included in the paving material ticket generated at 304. For example, such a low level of confidence may be below a third threshold level of confidence (less than the first and second threshold levels of confidence noted above). As a result, at 330 the controller 116 may maintain the association between the haul truck identifier identified at 306 and the location sensor 138 despite receiving an input including contradicting information (e.g., the unique identifier 144).

### INDUSTRIAL APPLICABILITY

The present disclosure provides systems and methods for associating a unique identifier 144 of a haul truck 104 with a particular location sensor 138 disposed on or within the haul truck 104. Such systems and methods may be used to more efficiently coordinate activities of the haul truck 104, paving machines 106, and/or other machines or equipment 200 during paving operations. For example, such systems and methods may enable a control system 114 to determine the location of a particular haul truck 104 with greater confidence. As a result, the control system 114 may schedule the pick-up and/or delivery of paving material 108 with improved accuracy, and thus, may maximize efficiency at a paving worksite 112. Additionally, such systems and methods may be used to more accurately manage the temperature of the paving material 108 at the paving plant 102, thereby reducing operating costs.

As noted above with respect to FIGS. 1-3, an example method 300 of associating a unique identifier 144 of a haul truck 104 with a particular location sensor 138 disposed on or within the haul truck 104 may include receiving a first signal from the location sensor 138. In some examples, such a first signal may include information indicating a first location of the haul truck 104 as determined by the location sensor 138. Such a first location may be within a perimeter 212 of the paving plant 102. For example, such a first location may comprise one of a plurality of locations 216, 220, 224 disposed proximate a paving material silo 202 of the paving plant 102. Respective geofences 218, 222, 226 of the control system 114 may be associated with each of the locations 216, 220, 224 within the perimeter 212. Alternatively, such a first location may comprise any other location outside of the perimeter 212 of the paving plant 102.

Such a method may also include generating a paving material ticket that includes information indicating paving material 108 loaded into the haul truck 104 at the paving plant 102. For example, as part of such a method the control system 114 may cause such paving material 108 to be loaded into a dump body 132 of the haul truck 104 at the paving material silo 202, and a controller 116 may generate a paving material ticket based at least partly on the haul truck 104 receiving the paving material 108 at the paving plant 102. In any of the examples described herein, such a paving material ticket may include the unique identifier 144 identifying the haul truck 104 with particularity. In some examples, the unique identifier 144 may be directly observed by one or more paving plant employees while the haul truck 104 is disposed at one or more of the locations 216, 220, 224 described above. Alternatively, one or more cameras, scanners, or other components of the paving plant 102 may directly observe the unique identifier 144 while the haul truck 104 is disposed at one or more of the locations 216, 220, 224. Further, such a method may include determining whether the first location noted above is within a geofence that is disposed within the perimeter 212 of the paving plant 102. In some examples, determining that the first location is within a geofence disposed within the perimeter 212 of the paving plant 102 may provide a relatively high level of confidence that the location sensor 138 providing the first signal noted above is actually disposed on or within the particular haul truck 104 identified by the unique identifier 144 included in the paving material ticket. Thus, the controller 116 may associated the unique identifier 144 of the haul truck 104 with the location sensor 138 in a memory connected to the controller 116 based at least partly on making such a determination. Utilizing such a method may minimize false associations between unique identifiers 144 of haul trucks 104 and location sensors 138 disposed on or within such haul trucks 104 caused by human error and other factors. Additionally, such a method may simplify the process of onboarding haul trucks 104 and/or other machines at the paving plan 102.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method, comprising:
receiving, with a controller of a paving plant, a first signal from a location sensor associated with a haul truck, the first signal including information indicating a first location of the haul truck determined by the location sensor;
generating a paving material ticket with the controller, the paving material ticket including information indicating paving material loaded into the haul truck at the paving plant and a first identifier unique to the haul truck; and
determining, with the controller, whether the first location is within a first geofence disposed within a perimeter of the paving plant, wherein based at least partly on determining that the first location is within the first geofence, the controller is configured to
associate the first identifier with the location sensor in a memory connected to the controller.

2. The method of claim 1, wherein the first geofence is disposed at one of an entrance to a paving material silo at the paving plant, a loading area of the paving material silo adjacent to the entrance, and an exit of the paving material silo adjacent to the loading area.

3. The method of claim 1, wherein the first signal includes a second identifier unique to the location sensor, and a first timestamp indicating a first time at which the first location of the haul truck was determined by the location sensor.

4. The method of claim 3, further comprising determining, with the controller and based at least partly on the second identifier, that
the location sensor is associated with a third haul truck identifier, and
the third haul truck identifier is different from the first identifier.

5. The method of claim 4, wherein based at least partly on determining that the third haul truck identifier is different from the first identifier, the controller is configured to:
determine that the first location is outside of the first geofence;
determine that the first location is outside of the perimeter of the paving plant based at least partly on a second geofence substantially overlaying the perimeter of the paving plant; and
determine whether the location sensor was associated with the haul truck identifier within a predetermined time range.

6. The method of claim 3, wherein:
the paving material ticket includes a second timestamp indicating a second time at which the paving material ticket was generated, and
associating the first identifier with the location sensor comprises determining the first time is within a predetermined range of the second time.

7. The method of claim 1, wherein the location sensor comprises a portable sensor removably disposed within the haul truck.

8. The method of claim 1, further comprising:
receiving a second signal, with the controller, from the location sensor, the second signal including information indicating a second location of the haul truck determined by the location sensor;
determining, with the controller, that the second location is within a second geofence disposed within the perimeter of the paving plant different from the first geofence; and
associating the first identifier with the location sensor based at least partly on the second signal.

9. The method of claim 1, wherein based at least partly on determining that the first location is outside of the first geofence, the controller is configured to determine whether the first location is within the perimeter of the paving plant based at least partly on a second geofence substantially overlaying the perimeter.

10. The method of claim 9, wherein the controller is configured to associate the first identifier with the location sensor based at least partly on determining that the first location is outside of the first geofence and within the perimeter of the paving plant.

11. A paving system, comprising:
a haul truck configured to transport paving material between a paving plant and a worksite, the haul truck including a first identifier unique to the haul truck;
a location sensor configured to determine a location of the haul truck; and
a controller disposed at the paving plant and in communication with the location sensor, the controller being configured to:
receive a first signal from the location sensor, the first signal including information indicating a first location of the haul truck determined by the location sensor;
generate a paving material ticket based at least partly on the haul truck receiving paving material at the paving plant, the paving material ticket including the first identifier; and
determine whether the first location is within a first geofence disposed within a perimeter of the paving plant, wherein based at least partly on determining that the first location is within the first geofence, the controller is configured to
associate the first identifier with the location sensor in a memory connected to the controller.

12. The paving system of claim 11, wherein the location sensor comprises a portable sensor removably disposed within the haul truck, and the controller is disposed within a scale house at the paving plant.

13. The paving system of claim 11, wherein the first geofence is disposed at an entrance to a paving material silo at the paving plant,
the first geofence being disposed adjacent to a second geofence disposed at a loading area of the paving material silo, and
the second geofence being disposed adjacent to a third geofence disposed at an exit of the paving material silo.

14. The paving system of claim 11, wherein the first signal includes a second identifier unique to the location sensor, and wherein the controller is configured to determine, based at least partly on the second identifier, whether the location sensor is associated with a third haul truck identifier different from the first identifier.

15. The paving system of claim 11, wherein based at least partly on determining that the first location is outside of the first geofence, the controller is configured to determine whether the first location is within a second geofence substantially overlaying the perimeter of the paving plant, and
based at least partly on determining that the first location is outside of the second geofence, the controller is configured to generate an alert corresponding to the location sensor.

16. A control system, comprising:
a location sensor configured to determine a location of a haul truck;
a controller; and
a wireless communication system configured to transmit signals between the location sensor and the controller, wherein the controller is configured to:
receive a first signal from the location sensor and via the wireless communication system, the first signal including information indicating a first location of the haul truck determined by the location sensor;
receive an input including information indicating a first identifier unique to the haul truck;
generate a paving material ticket, the paving material ticket including information indicating paving material loaded into the haul truck, and the first identifier; and
determine whether the first location is within a first geofence disposed within a perimeter of a paving plant, wherein based at least partly on determining that the first location is within the first geofence, the controller is configured to
associate the first identifier with the location sensor in a memory connected to the controller.

17. The control system of claim 16, wherein the paving material ticket is generated based at least partly on the haul truck receiving the paving material at the paving plant.

18. The control system of claim 17, wherein the input is received based at least partly on inspection of the haul truck at the paving plant.

19. The control system of claim 16, wherein the first signal includes a second identifier unique to the location sensor, and a first timestamp indicating a first time at which the first location of the haul truck was determined by the location sensor, the controller being configured to associate the first identifier with the location sensor based at least partly on the first time.

20. The control system of claim 16, wherein the first geofence is disposed at an entrance to a paving material silo at the paving plant, the control system further including:
a second geofence, adjacent to the first geofence, disposed at a loading area of the paving material silo,
a third geofence, adjacent to the second geofence, disposed at an exit of the paving material silo, and
a fourth geofence substantially overlaying the perimeter of the paving plant, wherein the first geofence, the second geofence, and the third geofence are disposed within the fourth geofence.
